(19) United States
(12) Patent Application Publication
(10) Pub. No.: US 2012/0112023 A1
(43) Pub. Date: May 10, 2012

(54) SUCTION FIXING

(75) Inventor: Stephen Paul Tollman, Hertfordshire (GB)

(73) Assignee: BB IPR Limited, Middlesex (GB)

(21) Appl. No.: 13/376,693

(22) PCT Filed: May 28, 2010
(86) PCT No.: PCT/GB10/50898

§ 371 Date: Jan. 20, 2012

(30) Foreign Application Priority Data
Jun. 8, 2009 (GB) 0909791.6

(51) Int. Cl. F16B 47/00

(52) U.S. Cl. 248/205.7; 248/205.8

(57) ABSTRACT

A suction fixing comprising a base unit (23) arranged to be fixed to a surface and to releasably engage with an article (44) to be fixed in place by the base unit (23), the base unit (23) comprises: a suction pad (28); an actuation mechanism to distort the suction pad to increase the volume between the suction pad (23) and any surface on which it is placed; a housing (24) attacked to the suction pad (23); and an engagement means (45) on the housing arranged to releasably engage with the article (44) that is to be fixed to the surface by the base unit (23), wherein the base unit (23) can be fixed to a surface prior to an article (44) being attached to it by the engagement means (45) and the actuation mechanism can be locked to prevent release.

The present invention relates to a suction fixing arranged to be attached to a substantially flat air-impervious surface and particularly, but not exclusively, to a suction fixing suitable for securing utensils, such as bowls and cups, to a tabletop.

A particularly simple type of suction fixing comprises a one piece moulded suction pad or cup in the form of concave disc, with an attachment portion moulded on to a rear face thereof, by which it is connected to an article to be attached to a surface. The suction pad is secured to the flat surface by being pressed into place, whereby air is expelled from the concaved portion and the resilient nature of the material, normally rubber or a soft plastic, then subsequently acts to adopt its original concave shape, maintaining a partial vacuum under the pad which retains the pad in place.

The above type of suction fixing is inexpensive to produce, but does not provide a particularly stable mounting. Any item attached to it is connected to a single point of contact at the centre of the suction pad, which point of contact is separated by an air gap from the surface and is thus only in contact with the surface by means of the flexible peripheral skirt portion of the suction pad.

An alternative type of suction fixing, which is also relatively inexpensive, is found on the bottom of some plastic mixing bowls and children's bowls. This comprises an annular ring, or downwardly protruding annular wall, moulded on the bottom of the bowl, with a soft rubber seal on a lower edge thereof. With this arrangement, the resilient properties of the bowl, or the resilient properties of the sealing material, can be used to create a small vacuum under the bowl by first pressing the bowl into contact with a surface. However, the partial vacuum created under the bowl is relatively low and this type of fixing is more useful in preventing the bowl from sliding than in preventing the bowl being removed from a surface.

A third type of common suction fixing employs a suction pad with a cam mechanism attached thereto and arranged to emphasise the concave nature of the surface of the suction pad. Such a suction fixing is placed on a flat surface and the cam mechanism operated to increase the concave shape below the suction pad and thus establish a strong vacuum under the suction pad. This type of fixing has the advantage that the materials of the suction pad can be relatively thick which, together with the relatively large partial vacuum created under the section pad, can create a relatively stable mounting. Such suction fixings can be used to mount a mirror to car windscreens for example, where a relatively stable fixing is required. US Patent 2006/85428 discloses such a fixing for retaining a mixing bowl in place on a work surface. This type of fixing has a number of component parts which have to be assembled and therefore is relatively expensive to produce and is not as easy to clean as the two previously described types of fixing.

It is an object of the present invention to provide an improved suction fixing.

According to the present invention, there is provided a suction fixing comprising a base unit arranged to be fixed to a surface and to releasably engage with an article to be fixed in place by the base unit, the base unit comprising: a suction pad; an actuation mechanism to distort the suction pad to increase the volume between the suction pad and any surface on which it is placed; a release mechanism to release the suction under the pad; a housing attached to the suction pad; and an engagement means on the housing arranged to releasably engage with the article to be fixed to the surface by the base unit, wherein the base unit can be fixed to a surface prior to an article being attached to it by the engagement means and wherein the article has to be removed from the base unit before the release mechanism can be operated to release the base unit from the surface.

A suction fixing in accordance with the present invention enables a base unit to be securely fixed to a surface by means of the suction pad of the base unit and the base unit to be locked in place. In this way the base unit can be securely fixed without the fixing process being hindered by the presence of the article which is to be fixed to the surface.

Furthermore, the article can then be fixed and released from the suction fixing without disturbing the suction fixing. Also a number of different articles may be fixed by a single type of base unit and they may be detached from the base unit for cleaning. They may also be arranged to be free standing when separated from the base. Of course, in some embodiments, it may be possible to also secure the article and base unit simultaneously, if the user desires this.
Where the article is a utensil, such as a bowl, this may be of particular advantage for use with young children or the disabled. The base unit can be secured firmly in place on a table and food placed in a freestanding utensil at a first location, before being transferred and secured to the base unit. The base unit, being locked in place, can then not be removed from the table so the utensil is not likely to be displaced by a small child playing or a person, who for example may only have use of one hand, trying to cut something in the utensil. However a supervisor may easily release the utensil for washing and replace it with a subsequent utensil, for example a cup with a straw.

In accordance with one aspect of the invention, the actuation mechanism is also the release mechanism and the base unit comprises a locking mechanism arranged to be manually released before the actuation mechanism can be operated to decrease suction between the suction pad and a surface to release the base unit from the surface.

In one embodiment of the invention, the actuation mechanism comprises, within the housing, a rotating member which can rotate relative to the housing but which is rotationally fixed relative to the suction pad, wherein: the rotating member and housing have interacting cam surfaces arranged such that rotation of the housing relative to the rotating member causes relative axial displacement of the housing relative to the rotating member; the housing is connected to a central region of the suction pad and the rotating member is arranged to contact an outer peripheral region of the suction pad such that rotation of the housing relative to the suction pad in a first direction causes the central region of the suction pad to be raised relative to the surface on which the fixing is placed and the outer peripheral region of the suction pad to be retained in place by the housing; and the locking mechanism is arranged to prevent relative rotation of the housing and rotating member and to lock the two in place.

A suction fixing in accordance with this embodiment of the invention may comprise a very compact and aesthetically pleasing base unit, which can be positioned and operated by simply placing the base unit on a surface and twisting it to establish the suction between the surface and the base unit.

Advantageously, the fixing further comprises an article having engaging means arranged to cooperate with the engaging means on the housing to enable the article to be mounted on and retained in place on the base unit by the engaging means, wherein the article, when mounted on the base unit, prevents the locking mechanism from being released.

The locking mechanism may have a lever extending from the housing which lever the article abuts when it is mounted on the base unit, thereby preventing operation of the lever until the article is first removed from the base unit.

In an alternative embodiment the fixing may further comprise an article having engaging means arranged to cooperate with the engaging means on the housing, wherein: the article can be mounted on and retained in place on the base unit by the engaging means; the actuation mechanism is also the release mechanism and is mounted on the top of the base unit; the article is arranged to cover the top portion of the base unit when attached to the base unit; and the article locks the actuation mechanism by preventing access to the actuation mechanism.

This above arrangement again prevents the actuation mechanism being used to release the base unit until the article is first removed and additionally also permits the base unit to be substantially enclosed within the base of the article. This is particularly advantageous where the article is in the form of a bowl with an annular rim as its base, whereby the bowl may function as an ordinary bowl, but permit the bowl to also be mounted on the base unit and the base unit to be accommodated in the base of the bowl. Thus when mounted on the base unit the bowl will adopt substantially the same position as when used without the base unit.

Advantageously, the actuator mechanism comprises a cam lever mounted on the top of the housing which is connected to a central region of the suction pad, the housing is arranged to contact an outer peripheral region of the suction pad and a cam surface on the cam lever acts against the housing to cause the central region of the suction pad to be raised relative to a surface on which the fixing is placed whilst the outer peripheral region is retained in place by the housing. Thus a suction can be created between the suction pad and a surface on which the fixing is placed to fix the base unit to the surface by simple operation of the cam lever.

The above arrangement provides a particularly stable base unit because the outer rigid wall of the housing tightly sandwiches the peripheral region of the suction pad to the table.

Preferably, the cam lever is arranged to be rotated from a raised position to a lowered position where it is substantially flush with the top surface of the base unit when the base unit is fixed to a surface. In this way, the base unit may be particularly compact with substantially flush outer surfaces.

In an alternative embodiment of the invention, the actuation mechanism comprises a spring arranged to bias the suction pad to a position to increase the volume between the suction pad and said surface and a button for depressing the suction pad against the action of the spring, such that the base unit can be fixed to a surface by initially depressing the button to decrease the volume between the suction pad and the surface.

In the above embodiment, the release mechanism may comprise an extended portion of the suction pad which extends beyond the periphery of the housing and which may be raised to release the suction under the pad, the fixing further comprising an article having engaging means arranged to cooperate with the engaging means on the housing to enable the article to be mounted on and retained in place on the base unit by the engaging means, wherein the article, when mounted on the base unit, prevents the extended portion being raised.

In any of the above embodiments of the present invention, the base unit may be circular wherein the fixing further comprises an article having a downwardly protruding annular wall arranged to fit over an outer wall of the base unit. Preferably the engagement means on the base unit then engage with the said annular wall of the article. In this manner, the base unit may be substantially concealed within the annular wall of the article which may be desirable for aesthetic reasons. Furthermore, a close fit may be provided between the annular wall and the base unit providing a particularly rigid fixing for the article.

Engagement means on the base unit may be outwardly biased pins arranged to engage with the apertures in the annular wall, which pins are depressed in order to release the article. Alternatively, the engagement means on the base unit may be keys or keyslots arranged to engage with corresponding keyslots or keys on the annular wall of the article, when the article is rotated in a first direction relative to the base unit. This enables the base unit to first be attached to a surface and then an article to be subsequently attached to the base unit by being twisted onto the base unit and released by being twisted off the bas unit. Preferably, the keyslots are shaped to initially resist rotation of the article to release it from the base unit such that when the article is installed on the base unit it is locked in position.

The fixing may comprise an article which in use has one or more correct rotational orientations and wherein the base unit is marked so that it may be correctly fixed to a surface, to ensure that when the article is subsequently attached to the base unit the article has the correct orientation.

Various embodiments of the present invention will now be described, by way of example, with reference to the accompanying drawings, in which like reference numerals are used throughout to indicate like parts and of which:

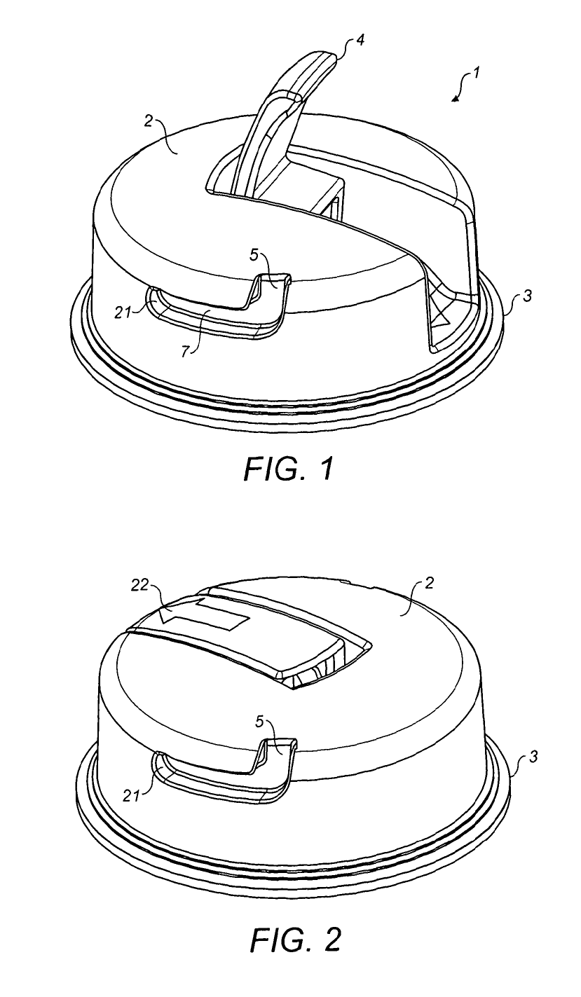

FIG. 1 is perspective view of a base unit of a suction fixing in accordance with the present invention, with a cam lever shown in a raised position;

FIG. 2 is a perspective view of the fixing of FIG. 1, with the cam lever shown in a lowered position;

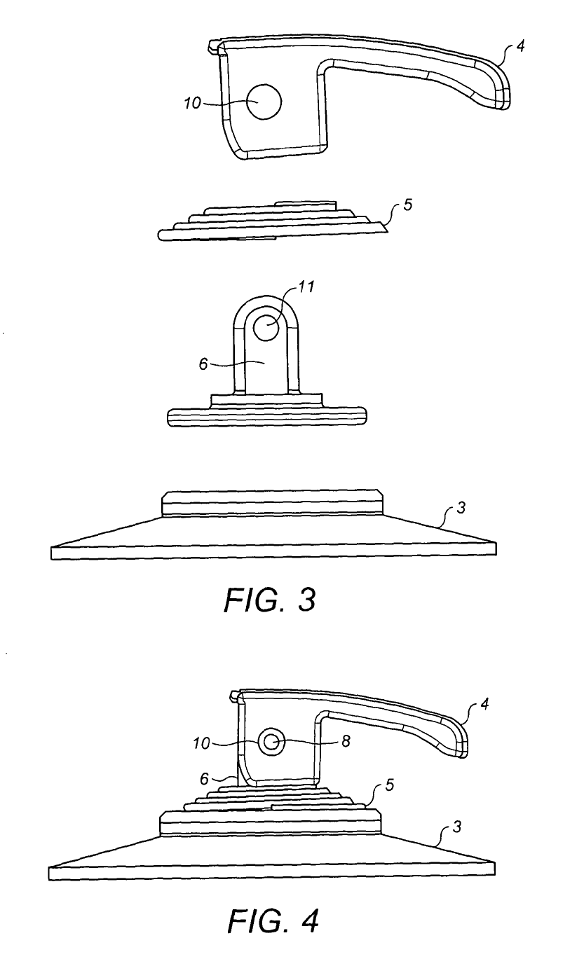

FIG. 3 shows selected components of the suction fixings of FIGS. 1 and 2;

FIG. 4 shows the components of FIG. 3 assembled;

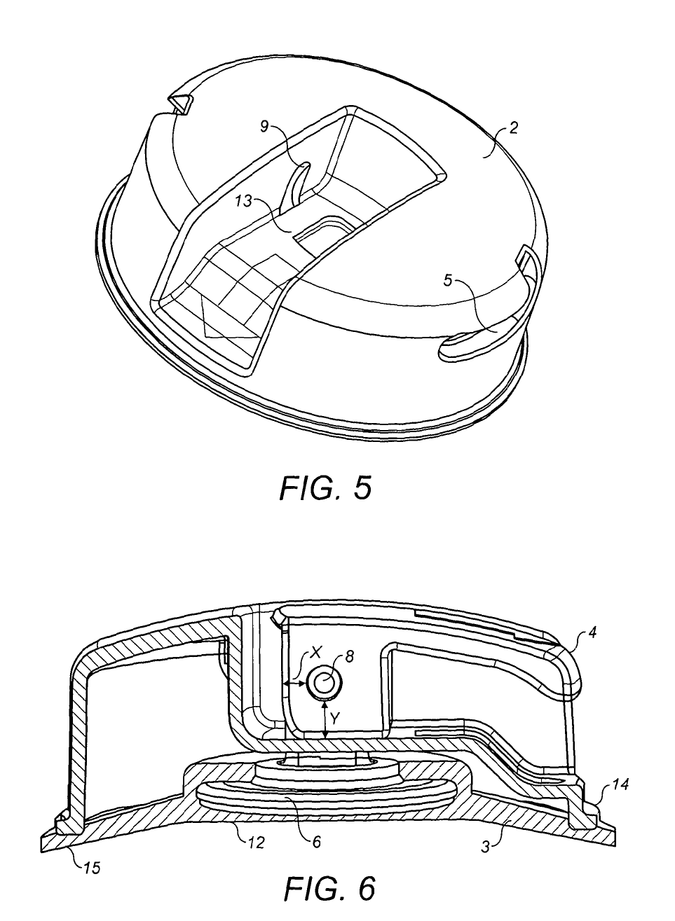

FIG. 5 shows the housing of the FIGS. 1 and 2 embodiments;

FIG. 6 is a cross section through the assembled components of the suction fixing illustrated in FIGS. 1 to 5;

FIG. 7 is a perspective of a bowl for use with the base unit of FIG. 1;

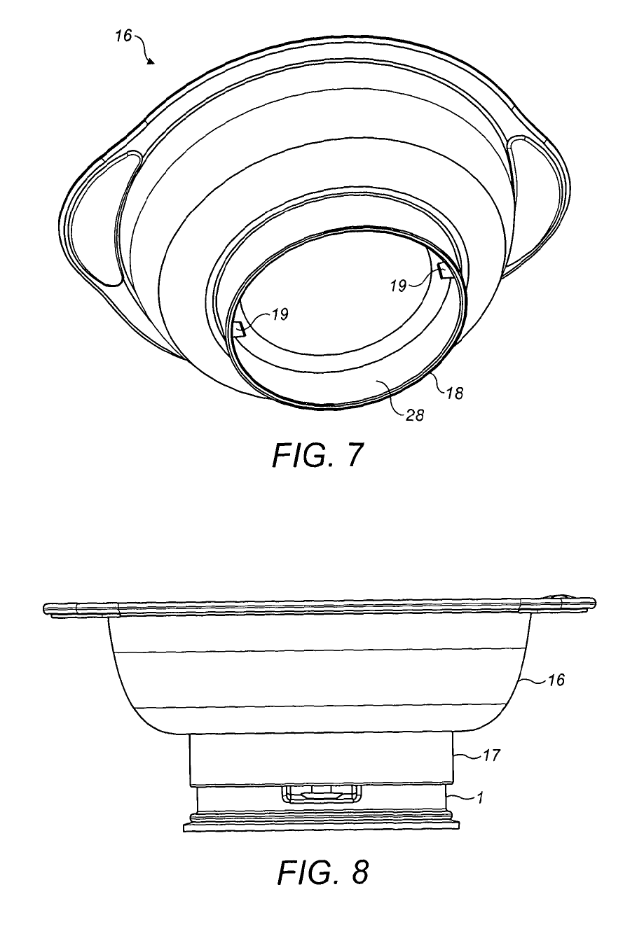

FIG. 8 is a side elevation of the bowl of FIG. 7 mounted on the base unit depicted in FIGS. 1 to 6;

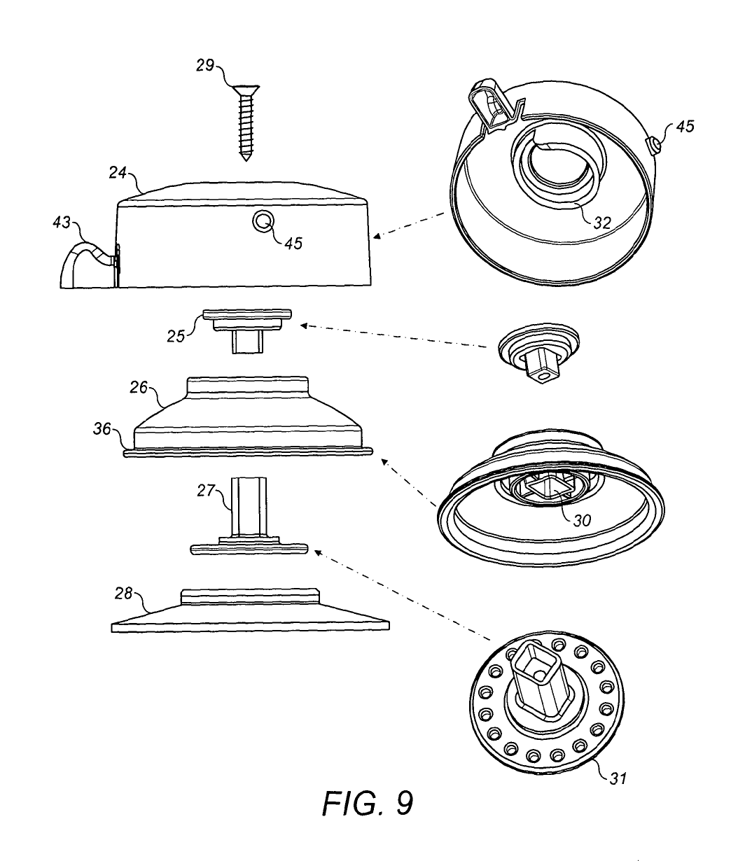

FIG. 9 illustrates the components of an alternative base unit of the suction fixing;

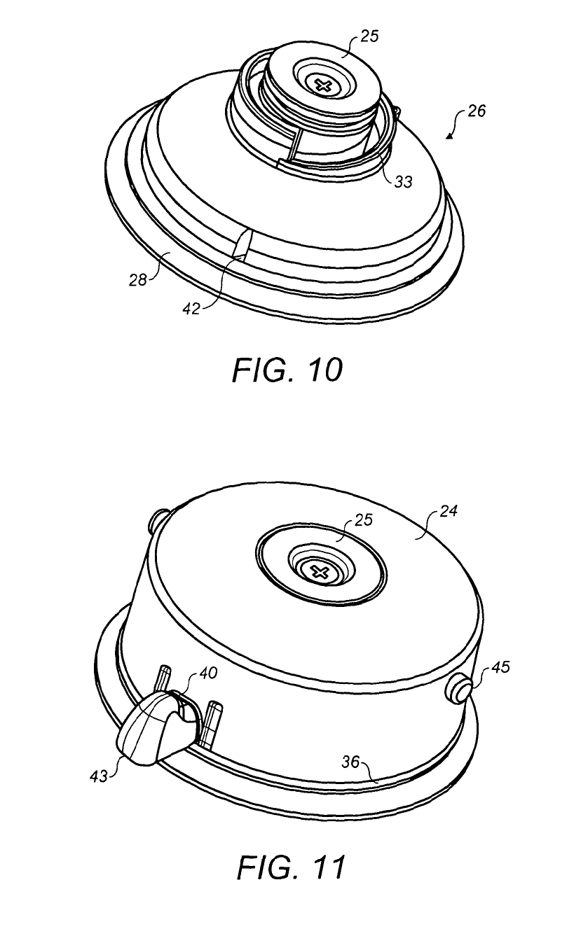

FIG. 10 is a perspective view showing components of the base unit of FIG. 9 assembled;

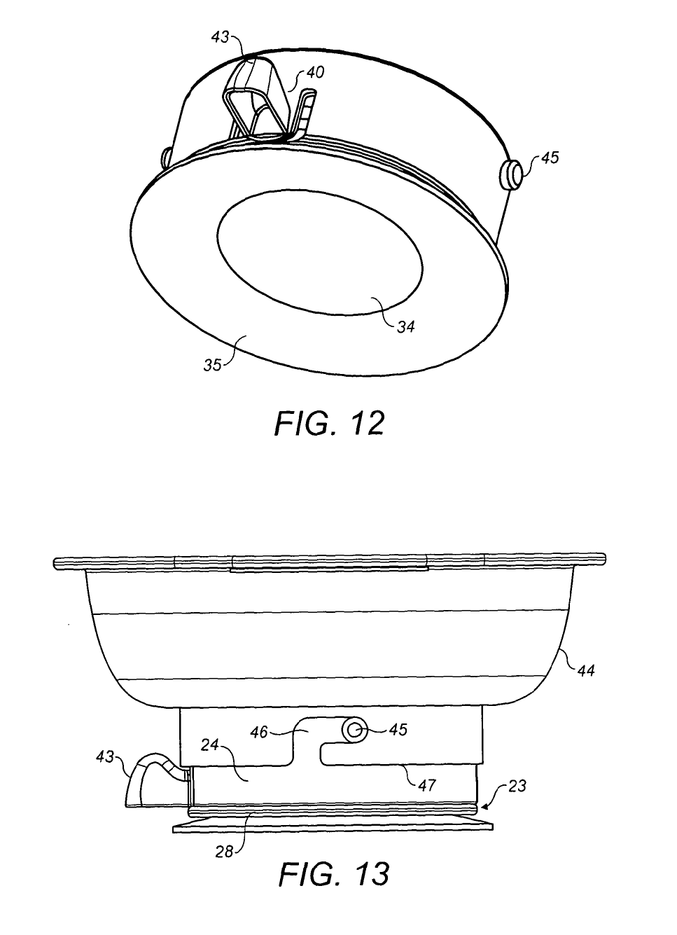

FIGS. 11 and 12 are perspective views of a base unit depicted in FIGS. 9 and 10;

FIG. 13 is a side elevation of a bowl mounted on the base unit depicted in FIGS. 11 and 12;

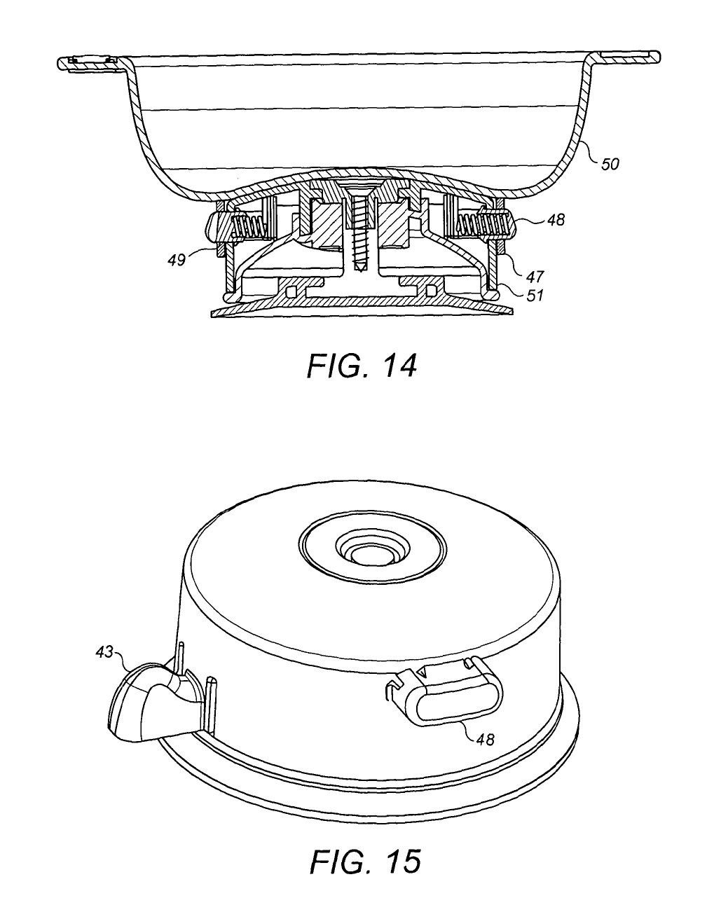

FIG. 14 is a cross section of a bowl mounted on a base unit in accordance with a further alternative embodiment of the present invention;

FIG. 15 is a perspective view of the suction fixing illustrated in FIG. 14;

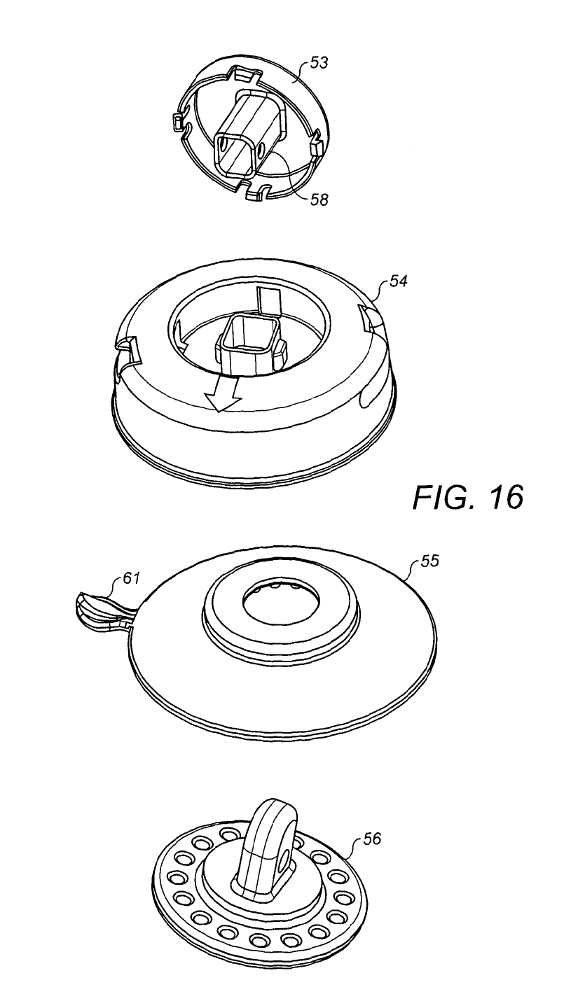

FIG. 16 shows selected components of an alternative base unit of a fixing of the present invention;

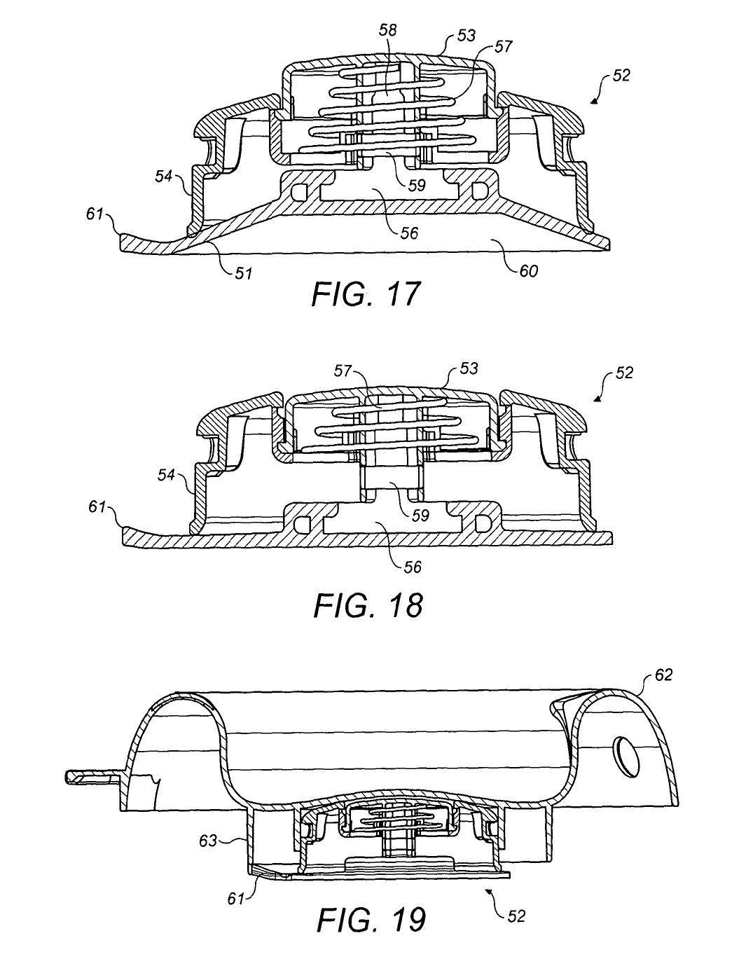

FIG. 17 is a cross section of a base unit of a fixing in accordance with the present invention comprising the components illustrated in FIG. 16 when in an initial release state;

FIG. 18 is a similar cross section to FIG. 17, but with the base unit in an actuated state; and

FIG. 19 is a cross section of the base unit as shown in FIG. 18 with an article attached thereto.

Referring to FIG. 1, a base unit 1 of a suction fixing in accordance with the present invention comprises a housing 2, suction pad 3 and a cam lever 4, shown in a raised position. The housing 2 has key slots 5 moulded on opposite sides thereof, only one of which can be seen in FIG. 1.

FIG. 2, a perspective view of the base unit 1 showing the opposite side to that of FIG. 1 and with the cam lever 4 in a lowered position. The cam lever 4 has an alignment arrow 22 on its upper surface.

FIGS. 3 to 6 show the components of an actuator assembly of the base unit 1. These comprise the cam lever 4, coil compression spring 5, rigid plastic shaft 6 and rubber suction pad 7. These are assembled in the housing 2, illustrated in FIG. 5. The assembled components are shown in FIG. 4, but with the housing 2 omitted for clarity. The shaft 6 is inserted through: the base of the pad 7; the spring 5; the housing 2 (not shown); and the cam lever 4. The spring 5 is retained in a compressed state with the assembled components retained in place by a pin 8 (see FIG. 4) inserted through a cut out 9 in the housing 2 (see FIG. 5).

The assembled components, including the housing 2, are shown in cross section in FIG. 6. Here the distance labelled “X” is seen to be greater than the distance labelled “Y” due to the profile of the cam surface of the cam lever 4. Therefore, when the cam lever 4 is raised, as shown in FIG. 1, a central region of the suction pad 3 is at its lowest position and when the cam lever 4 is closed, as illustrated in FIGS. 2 and 6, the cam action of the cam lever against surface 13 (see FIG. 5) of housing 2 acts on the shaft 6 to raise the central region 12 of the suction pad 3. The cam lever 4 is biased towards either of the positions shown by the action of the spring 5.

With the cam lever 4 in the position shown in FIGS. 2 and 6 the outer peripheral edge 14 of the housing 2 applies downward pressure to outer peripheral region 15 of the suction pad 3, forcing it to adopt an attenuated concave shape as the central region 12 is raised. If the base unit 1 is placed on a smooth, air-impervious, surface and the cam lever 4 lowered, attenuation of the concave shape of the lower surface of the suction pad 3 increases the volume of the cavity below the suction pad 3, causing the base unit 1 to be affixed to the surface by suction.

When the base unit 1 of FIGS. 1 to 6 has been attached to a surface, a bowl 16, as illustrated in FIGS. 7 and 8 or other similar shaped utensil, may be attached to the base unit 1. The bowl 16 has a lower annular rim 17 with keys 19 extending inwardly from an inner surface 20 thereof. The bowl is orientated such that the keys 19 are aligned with the key slots 5 of the base unit 1, whereupon the bowl is lowered and rotated such that the keys 19 engage with the key slots 5. As shown in FIG. 1, the key slots 5 have a lower central portion 7. Rotation of the bowl in a first direction locates the keys 19 at the ends 21 of the key slots 5. When it is desired to release the bowl 16, the bowl 16 is rotated in the opposite direction with sufficient force to force the keys 19 past the lower central portion 7 of the key slots 5. Alternatively the key slots 5 may have two separate lower portions such that on rotation to release the bowl 16, the bowl 16 is first partially released by passing the first protrusions on the key slots 5 to a mid position on the key slots 5, with continued rotation past the second protrusion of each key slot 5 being required to release the bowl completely.

Referring to FIG. 8, the bowl 16 is shown mounted on the base unit 1. When mounted on the base unit 1, the bowl 16 is only a few millimetres higher than when directly stood on the surface. Also with reference to FIG. 8, it is seen that the base unit 1 is substantially housed within the lower annular rim 17 of the bowl 16. This prevents the base unit 1 being released by the bowl 16 locking the cam lever 4 in the position shown in FIG. 2.

In addition to the above, because the lower annular rim substantially covers the base unit 1, the invention may be applicable to other applications, for example in securing articles such as bathroom or kitchen fittings to a tiled wall. The fitting would be secured by first securing the base unit 1 and subsequently securing the fixing to the base unit 1 and obscuring the base unit 1 from view. In this manner a common base unit may be used with any number of fittings.

The base unit 1, seen in FIG. 2, has an arrow 22 marked on it. This may be used to correctly orientate the base unit, for example to point at a user if the base unit is to be used to mount a bowl, so that when the bowl or other item is mounted on it, it is correctly aligned.

Referring to FIGS. 9 to 13 a base unit 23, shown in perspective in FIGS. 11 and 12, comprises the components illustrated in FIG. 9. These are shown in side elevation to the left of Figure (with the same components shown in perspective views to the right of FIG. 9 to assist in the understanding of the assembly of the components).

The base unit 23 comprises a housing 24, an upper shaft 25, a rotating member 26, a lower shaft 27, suction pad 28 and screw 29. The shaft 27 is inserted through the base of the suction pad 28 and through the rotating member 26 into the housing 24. The upper shaft 25 is then inserted through the top of the housing and into the rotating member 26, whereupon the assembly is screwed together by screw 29 screwing the upper shaft 25 to the lower shaft 27. The upper shaft 25, rotating member 26, lower shaft 27 and suction pad 28 are joined together and prevented from rotating relative to each other by the square shafts 25 and 27 engaging with square aperture 30 within the rotating member 26 and lugs (not shown) on the lower side of the suction pad 28 engaging with the apertures 31, on the lower shaft 27. Thus, these components are rigidly fixed together, (with the exception that the rotating member 26 can slide up and down on the shaft), as illustrated in FIG. 10, from which housing 24 has been omitted. The assembly of FIG. 10 is retained in the housing 24 by the top section of the upper shaft 25 and the outer edge of the suction pad sandwiching the housing 24 between them.

On the lower surface of the housing 24 is a first cam surface 32 which engages with a second cam surface 33 formed on the rotating member 30 (see FIG. 10). Thus, relative rotation of the housing 24 relative to the suction pad 28 and thus the rotating member 26, causes the cam surfaces 32 and 33 to interact with each other, axially separating the rotating member 26 from the housing 24.

In use, the base unit 23, illustrated in FIGS. 11 and 12, is placed on a surface to which it is to be affixed and the housing 24 rotated. The suction pad 28 will not slip when firmly pressed against the surface, but instead the housing 24 rotates relative to the suction pad 28 and rotating member 26, causing the housing 24 to move axially away from the rotating member 26.

The housing 24 raises the upper shaft 25, lifting the lower shaft 27 causing it to slide through the square aperture 30 in the rotating member 26. This raises the central region 34 of the suction pad 28 (see FIG. 12) relative to an outer peripheral region 35 of the suction pad, which is retained in contact with the surface by the peripheral edge 36 of the rotating member 26.

As shown in FIGS. 9, 11 and 12, an outer wall 37 of the housing 24 has cuts 38 and 39 defining a resiliently flexible section of wall 40. This has an inwardly protruding pip 41 (see FIG. 9) which engages with notch 42 in rotating member 26.

As the housing 24 is rotated, causing the housing 24 to move axially away from the rotating member and forcing the central region 34 of the suction pad 28 to be drawn into the rotating member 26, the pip 41, biased by the resilient section 40, engages the notch 42 and locks the rotating member in a fixed rotational position relative to the housing 24. This retains the rotating member 26 and housing 24 in a fixed axial separation, thus maintaining any suction generated between the suction pad 28 and the surface on which it is placed.

To release the base unit 23, lever 43 attached to the resilient section 40 is lifted, disengaging the pip 41 from the notch 42. The housing 24 may then be rotated in an opposite direction, returning the base unit to its original position and releasing any suction below the base unit 1.

When the base unit 23 has been attached to a surface as described above then, as shown in FIG. 13, a bowl 44, similar utensil or fixture or fitting, may be secured to the base unit 23 in a similar manner to which, in the previously described embodiment, the bowl 44 of FIG. 7 is secured to the base unit illustrated in FIGS. 1 and 2.

In the FIG. 13 embodiment, the base unit 23 has keys in the form of protrusions 45 which engage with key slots 46 in the base of the bowl 44. However, these are functionally equivalent to the keys and key slots of the first embodiment and they are given as an example of one of many alternative arrangements for engaging the bowl 44 to the base unit. When the bowl 44 is mounted on the base unit 23 the lower edge 47 of the bowl 44 comes into contact with the lever 43. This prevents the lever being lifted and the thus the base unit released until the bowl 44 has first been removed from the base unit 23.

Referring now to FIGS. 14 and 15, a further alternative embodiment of a suction fixing in accordance with the present invention is illustrated. This is essentially the same as that illustrated in FIGS. 9 to 13, with the exception that the keys 45 and key slots 46 of the FIGS. 9 to 13 embodiments have been replaced with sprung loaded pins 48, which engage with holes 49 in the bowl 50. This enables the bowl 50 to be placed vertically on to the base unit 51 after the base unit 51 has been secured to the surface in the manner described with reference to FIGS. 9 to 13. To release the bowl 50, the pins 48 have to be simultaneously pressed in. Because, the lower edge 47 of the bowl 50 engages with lever 43 preventing the base unit being released until the bowl 50 has been removed, this makes it difficult for a small child to release the bowl from the surface.

A further alternative embodiment of a suction fixing is illustrated in FIGS. 16 to 19. The main components of the base unit, illustrated generally as 52 in FIGS. 17 to 19, comprises a button 53, a housing 54, a suction pad 55 and a lower shaft 56. As shown in FIGS. 17 and 18, when assembled, a spring 57 is sandwiched between the cap 53 and housing 54. An upper shaft 58, forming part of the button 53 passes through the housing 54 and suction pad 55, engages with the lower shaft 56 and is retained in place by means of pin 59.

When assembled, as shown in FIG. 17, the spring 57 urges the button 53 and thus the central section of the suction pad 55 vertically upwards, whilst the peripheral wall of the housing 54 retains the peripheral portion of the suction pad 55 in a lower position than that of the central portion of the suction pad, therefore defining volume 60 below the suction pad.

To affix the suction pad to a surface (not shown) the base unit is placed on the surface and the button 53 depressed, as shown in FIG. 18, reducing the volume 60 below the suction pad and expelling the air from below the suction pad 55. This action maintains the base unit 52 in place on the surface, because any attempt to pull the base unit 52 away from the surface will create a vacuum under the suction pad 55, which acts to retain the base unit in place.

In order to release the base unit, the suction pad 55 has an extended portion 61 which extends beyond the wall of the housing 54. This can be raised to permit air to enter below the suction pad 55 and thus, in this embodiment, the extended portion forms the release mechanism for the base unit 52. Once the base unit has been fixed to a surface an article 62, such as a bowl or cup, may be attached to it, as shown in FIG. 18, in the manner described in the previous embodiments. The article 62 has a downwardly protruding annular skirt 63 which prevents access to the extended portion 61 of the suction pad 55 when the article 62 is attached to base unit 52. Therefore, in order to release the base unit 52 it is first necessary to remove the article 62 from the base unit, to enable the release mechanism, in the form of the extended portion 61, to be raised in order to release the base unit.

In a variation of the embodiment disclosed in FIGS. 17 to 19, the extended portion 61 of the suction cup 55 could be omitted, avoiding the need for a skirt on the article 62 to shield the extended portion 61. In this alternative embodiment, means would be provided on the button 53 and housing 54 to enable the button to be locked (possibly by being rotated) in a depressed state. Thus to secure the base unit 52, the button 53 would be depressed in the manner described with reference to FIGS. 17 to 19, with the spring subsequently acting to maintain a vacuum under the suction pad 55. Then to release the base unit 52 the button 53 would be depressed again and locked in the fully depressed state, whereby any partial vacuum below the suction pad 55 would be destroyed, permitting the base unit to then be lifted off the surface. In this embodiment, the article 62 would again have to be removed before the button 53 could be depressed to release the base unit.

Several embodiments of the present invention have been described above by way of example and the skilled person will appreciate that any number of alternative embodiments may be possible within the scope of the appended claims.

1. A suction fixing comprising a base unit arranged to be fixed to a surface and to releasably engage with an article to be fixed in place by the base unit, the base unit comprising:
a suction pad;
an actuation mechanism to distort the suction pad to increase the volume between the suction pad and any surface on which it is placed;
a release mechanism to release the suction under the pad;
a housing attached to the suction pad; and
an engagement means on the housing arranged to releasably engage with the article to be fixed to the surface by the base unit, wherein the base unit can be fixed to a surface prior to an article being attached to it by the engagement means and wherein the article has to be removed from the base unit before the release mechanism can be operated to release the base unit from the surface.

2. A suction fixing as claimed in claim 1, wherein the actuation mechanism is also the release mechanism and the base unit comprises a locking mechanism arranged to be manually released before the actuation mechanism can be operated to decrease suction between the suction pad and a surface to release the base unit from the surface.

3. A suction fixing as claimed in claim 2 wherein the actuation mechanism comprises, within the housing, a rotating member which can rotate relative to the housing but which is rotationally fixed relative to the suction pad, wherein:
the rotating member and housing have interacting cam surfaces arranged such that rotation of the housing relative to the rotating member causes relative axial displacement of the housing relative to the rotating member;
the housing is connected to a central region of the suction pad and the rotating member is arranged to contact an outer peripheral region of the suction pad such that rotation of the housing relative to the suction pad in a first direction causes the central region of the suction pad to be raised relative to the surface on which the fixing is placed and the outer peripheral region of the suction pad to be retained in place by the housing; and
the locking mechanism is arranged to prevent relative rotation of the housing and rotating member and to lock the two in place.

4. A suction fixing as claimed in claim 3, further comprising an article having engaging means arranged to cooperate with the engaging means on the housing to enable the article to be mounted on and retained in place on the base unit by the engaging means, wherein the article, when mounted on the base unit, prevents the locking mechanism from being released.

5. A suction fixing as claimed in claim 4, wherein the locking mechanism has a lever extending from the housing which the article abuts when it is mounted on the base unit, thereby preventing operation of the lever.

6. A suction fixing as claimed in claim 1, further comprising an article having engaging means arranged to cooperate with the engaging means on the housing, wherein:
the article can be mounted on and retained in place on the base unit by the engaging means;
the actuation mechanism is also the release mechanism and is mounted on the top of the base unit;
the article is arranged to cover the top portion of the base unit when attached to the base unit; and
the article locks the actuation mechanism by preventing access to the actuation mechanism.

7. A suction fixing as claimed in claim 6, wherein: the actuation mechanism comprises a cam lever mounted on the top of the housing which is connected to a central region of the suction pad;
the housing is arranged to contact an outer peripheral region of the suction pad;
a cam surface on the cam lever acts against the housing to cause the central region of the suction pad to be raised relative to a surface on which the fixing is placed, whilst the outer peripheral region is retained in place by the housing.

8. A suction fixing as claimed in claim 7, wherein the cam lever is arranged to be rotated from a raised position to a lowered position where it is substantially flush with the top surface of the base unit when the base unit is fixed to a surface.

9. A suction fixing as claimed in claim 1, wherein the actuation mechanism comprises a spring arranged to bias the suction pad to a position to increase the volume between the suction pad and said surface and a button for depressing the suction pad against the action of the spring, such that the base unit can be fixed to a surface by initially depressing the button to decrease the volume between the suction pad and the surface.

10. A suction fixing as claimed in claim 9, wherein the release mechanism comprises an extended portion of the suction pad which extends beyond the periphery of the housing and which may be raised to release the suction under the pad, the fixing further comprising an article having engaging means arranged to cooperate with the engaging means on the housing to enable the article to be mounted on and retained in place on the base unit by the engaging means, wherein the article, when mounted on the base unit, prevents the extended portion being raised.

11. A suction fixing as claimed in claim 1, wherein the base unit is circular and further comprising an article having a downwardly protruding annular wall arranged to fit over the base unit.

12. A suction fixing as claimed in claim 11, wherein the engagement means on the base unit engages with an downwardly protruding annular wall of the article.

13. A suction fixing as claimed in claim 12, wherein the engagement means on the base unit are outwardly biased pins arrange to engage with apertures in the annular wall.

14. A suction fixing as claimed in claim 12, wherein the engagement means on the base unit are one of keys or keyslots arranged to engage with corresponding keyslots or keys on the annular wall of the article when the article is rotated in a first direction relative to the base unit.

15. A suction fixing as claimed in claim 14, wherein the article can be released by rotation in a direction opposite to the first direction but wherein the keyslots are shaped to initially resist rotation.

16. A suction fixing as claimed in claim 1, comprising an article in the form of a bowl or cup.

17. A suction fixing as claimed in claim 1, comprising an article which in use has one or more correct rotational orientations and wherein the base unit is marked so that it may be correctly fixed to a surface to ensure that when the article is subsequently attached the article has the correct orientation.

18. (canceled)

19. (canceled)

20. A suction fixing comprising a base unit arranged to be fixed to a surface and to releasably engage with an article to be fixed in place by the base unit, the base unit comprising:
a suction means;
an actuation means for distorting the suction means to increase the volume between the suction means and any surface on which it is placed;
a release means for releasing the suction means under the pad;
a housing means attached to the suction means; and
an engagement means on the housing arranged to releasably engage with the article to be fixed to the surface by the base unit, wherein the base unit can be fixed to a surface prior to an article being attached to it by the engagement means and wherein the article has to be removed from the base unit before the release means can be operated to release the base unit from the surface.
